(19) United States
(12) Patent Application Publication
(10) Pub. No.: US 2026/0306989 A1
(43) Pub. Date: Oct. 8, 2026

(54) METHOD AND DEVICE FOR SEPARATING A CARBON DIOXIDE-CONTAINING GAS BY PARTIAL CONDENSATION AND/OR DISTILLATION AND/OR SOLIDIFICATION

(71) Applicant: L'Air Liquide, Societe Anonyme pour l'Etude et l’Exploitation des Procedes Georges Claude, Paris (FR)

(72) Inventors: Felix PERE, Champigny Sur Marne (FR); Jean-Baptiste CHAIX, Champigny Sur Marne (FR); Richard DUBETTIER-GRENIER, Champigny Sur Marne (FR)

(21) Appl. No.: 19/482,133

(22) PCT Filed: Apr. 17, 2024
(86) PCT No.: PCT/EP2024/060359

§ 371 Date: Nov. 6, 2025

(30) Foreign Application Priority Data
May 10, 2023 (FR) FR2304615
Feb. 5, 2024 (FR) FR2401097

(51) Int. Cl. B01D 53/00; B01D 53/04; F23J 15/02; F25J 3/08

(52) U.S. Cl. CPC B01D 53/002; B01D 53/005; B01D 53/04; F23J 15/02; F25J 3/08; B01D 2257/404; B01D 2257/504; B01D 2257/602; B01D 2258/0283; F23J 2215/10; F23J 2215/50; F23J 2215/60; F23J 2219/70

(57) ABSTRACT

A device for separating a gas containing CO₂, at least one air gas and mercury comprises a turbocharger, a turbine coupled to the turbocharger, a demercurization unit, a cooler, a heater, a separation unit operating at temperatures below 10 °C, means for sending the gas containing CO₂, at least one air gas and mercury to the turbocharger, means for sending the compressed gas in the turbocharger to the demercurization unit to form a demercurized gas after heating in the heater, means for sending the demercurized gas to the cooler and from the cooler to the separation unit to produce at least one fluid containing at least 95 mol % or at least 99 mol % of CO₂ and a pressurized stream of CO₂-depleted gas, and means for sending at least a portion of the CO₂-depleted gas to expand in the turbine coupled to the turbocharger.

### CROSS REFERENCE TO RELATED APPLICATIONS

This application is a § 371 of International PCT Application PCT/EP 2024/060359, filed Apr. 17, 2024, which claims the benefit of FR2304615, filed May 10, 2023, and FR2401097, filed Feb. 5, 2024, all of which are herein incorporated by reference in their entireties.

### FIELD OF THE INVENTION

The present invention relates to a process and to a device for separating a carbon dioxide-containing gas, at least one air gas, and mercury, and also possibly NO₂, by partial condensation and/or distillation and/or solidification.

### SUMMARY OF THE INVENTION

Air gases include nitrogen, oxygen or argon.

In certain embodiments, the present invention relates to the integration of a demercurizer in a unit for scavenging CO₂ coming from a gas containing CO₂, which may be, for example, fumes from combustion processes.

According to one subject of the invention, a process is provided for separating a gas containing CO₂, at least one air gas and mercury, involving the following steps:
i) compressing the gas in a turbocharger coupled to a turbine forming, a compressed gas,
ii) heating the compressed gas upstream or downstream of the compressor, and demercurization of the heated compressed gas in one or more non-regenerative mercury adsorption reactors, producing a demercurized gas,
iii) cooling the demercurized gas,
iv) separating the cooled gas in a unit operating at temperatures below 10 °C or even below −50 °C by partial condensation in one or more stages and/or by distillation and/or solidification, producing at least one fluid containing at least 95 mol % or even at least 99 mol % of CO₂ and a pressurized stream of CO₂-depleted gas and
v) at least part of the CO₂-depleted gas is expanded in the turbine coupled to the turbocharger, possibly after being heated to a temperature above 10 °C.

According to other optional subjects:
the compressed gas is heated to a temperature of between 50 and 150 °C, or even between 100 °C and 150 °C upstream of the demercurizer.
the demercurized gas is cooled by indirect heat exchange with a refrigerant fluid, the refrigerant fluid, preferably water, used to cool the demercurized gas is used to heat the compressed gas in the heater.
the compressed gas is heated by an electric heater and/or by a heat-generating fluid.
the compressed gas or the gas to be compressed is heated by indirect heat exchange with the gas treated in the demercurizer.
indirect heat exchange takes place in a heat exchanger in which the compressed gas or the gas to be compressed is heated and in which the gas treated in the demercurizer cools.
the demercurized gas is cooled by indirect heat exchange with a refrigerant fluid.
the refrigerant fluid, preferably water, used to cool the demercurized gas is then used to heat a regeneration gas from a gas dryer containing CO₂, at least one air gas and mercury.
a refrigerant fluid used to cool the demercurized gas is then used to heat at least part of the CO₂-depleted gas to be expanded in the turbine.
the refrigerant fluid, preferably water, used to cool the demercurized gas is used to heat the compressed gas.
the refrigerant fluid, preferably water, used to cool the demercurized gas, is used for heating and/or cooling at least one building.
the refrigerant fluid is water which has been used to cool the demercurized gas, and is heated to generate water vapor.
the refrigerant fluid, preferably water, used to cool the demercurized gas is used to vaporize a purge liquid of the separation operating at less than 10 °C.
the refrigerant fluid, preferably water, used to cool the demercurized gas is used to superheat a wet gas.
the refrigerant fluid, preferably water, used to cool the demercurized gas is used to heat a flow intended to be expanded in a turbine
the CO2-depleted gas is enriched with at least one air gas, for example nitrogen and/or oxygen and/or argon.
the gas containing CO2, at least one air gas and mercury contains NO2 and is treated to remove the NO2 in a unit that removes NO2 to a concentration of less than 5 ppm, or even less than 1 ppm of NO2, producing an NO2-depleted gas upstream of compression in the turbocharger.
the treatment to remove NO2 is a process of separation by partial condensation and/or distillation.
the gas containing CO2, at least one air gas and mercury and possibly NO2 is composed of combustion fumes.
the gas containing CO2, at least one air gas and mercury, and possibly NO2, is composed of combustion fumes separated out by adsorption to reduce their content of the at least one air gas.

According to another subject of the invention, a device is provided for separating a gas containing CO₂, at least one air gas and mercury, comprising a turbocharger, a turbine coupled to the turbocharger, a demercurization unit, a cooler, a heater, a unit (CC) for separation by partial condensation in one or more stages and/or by distillation operating at temperatures below 10 °C or even below −50 °C, means for sending the gas containing CO₂, at least one air gas and mercury to the turbocharger, the heater being connected to heat the gas upstream or downstream of the turbocharger, means for sending the compressed and heated gas to the demercurization unit to form a demercurized gas, means for sending the demercurized gas to the cooler and from the cooler to the separation unit to produce at least one fluid containing at least 95 mol % or even at least 99 mol % of CO₂ and a pressurized stream of CO₂-depleted gas and means for sending at least part of the CO₂-depleted gas to expand in the turbine coupled to the turbocharger.

According to other optional features, the device comprises:
means for cooling the demercurized gas by indirect heat exchange with a refrigerant fluid.
the heater is downstream of the means for cooling the demercurized gas by indirect heat exchange with a refrigerant fluid and is connected so that the refrigerant fluid, preferably water, used to cool the demercurized gas is used to heat the compressed gas.
an electric heater to heat the compressed gas.
a heat exchanger connected to effect indirect heat exchange between the compressed gas or the gas to be compressed and the gas treated in the demercurizer.

Fumes from combustion processes contain large amounts of CO2. Scavenging of the CO2 contained in these fumes is one of the approaches envisaged for reducing the effects of climate change.

These fumes contain many pollutants, including mercury. Mercury can prove to be particularly damaging to aluminum equipment, as it forms a liquid metal complex therewith leading to gradual destruction.

As a result, processes using aluminum equipment (such as cryogenic processes) remove mercury, or shift to more expensive stainless steel equipment.

Mercury removal is a well-known process, and is typically performed by adsorption on sulfidized metals or sulfidized activated carbon. It may require heating to limit the amount of NO₂ adsorbed (if present) and thus to eliminate the risk of self-ignition of the adsorbent bed. A heat exchanger can recover some of the heat from the treated gas and minimize the heating requirements.

However, the use of the usual adsorbents may be hindered by the presence of nitrogen oxides (NO_{X}), and notably NO₂. Therefore, when these combustion products are present in the fumes, they must be removed prior to demercurization.

One object of the invention is to minimize the heating energy required for demercurization, while preferably recovering part of this heat for other uses in the scavenging process.

The invention proposes an integrated scheme for minimizing the need for heat and for exploiting the heat used for other consumers of the process.

The invention proposes to treat a gas containing CO₂, mercury, nitrogen or another component of air, and also possibly NO₂. For example, this gas could be composed of fumes from a combustion unit, or fumes pre-concentrated by a first treatment, such as a pressure swing adsorption (PSA) unit.

These fumes are initially treated to have NO₂ removed if they contain it, typically down to 5 ppm or even 1 ppm of NO₂. This treatment may, for example, be a low-temperature treatment such as partial condensation and/or distillation (with optional upstream drying of the gas).

The gas, stripped of its NO₂ (if present), is then compressed in a turbocharger. The gas leaving the machine is hot, and is heated even further to reach the conditions necessary for demercurization. The temperature required at the inlet of the demercurizer may typically be greater than 100 °C, whereas the temperature at the outlet of the turbocharger is typically less than 80 °C.

The gas is then passed through an adsorptive demercurizer, and the demercurized gas is cooled in an exchanger against a refrigerant fluid (for example water). The outlet temperature of this water is maximized, and the heat it contains can be reused elsewhere in the process (regeneration of dryers, gas preheating, heating of buildings, cold production, steam production, etc.).

The compressed and demercurized gas is then treated in a unit operating by partial condensation and/or distillation, in one or more stages. This unit produces CO2, while the non-condensable fraction of the fumes leaving the unit is expanded in the turbine coupled to the abovementioned compressor.

This non-condensable matter may optionally be superheated before expansion, for example against all or part of the heat transfer fluid recovering the heat upstream of the demercurizer.

The process may comprise the following characteristics:
the NO2 (if present) is withdrawn prior to demercurization
the gas is compressed prior to demercurization
the heat of compression is exploited to minimize the heating needs before demercurization
the residual heat is recovered and reused
the compressor is driven by expansion of the non-condensable matter from the partial condensation.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 diagrammatically illustrates a process according to the invention.

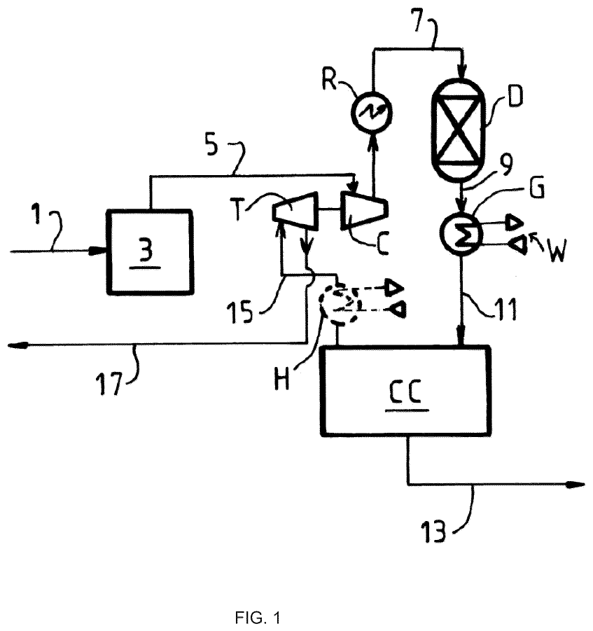

FIG. 2 shows a variant of the heating means of the process according to FIG. 1.

FIG. 3 shows a variant of the heating means of the process according to FIG. 1.

FIG. 4 shows a variant of the heating means of the process according to FIG. 1.

### DETAILED DESCRIPTION OF THE INVENTION

A gas 1 contains CO₂, NO₂, at least one air gas and mercury and may be combustion fumes.

Gas 1 is treated in a unit 3 which removes NO₂ to a concentration of less than 5 ppm or even 1 ppm of NO₂, producing an NO₂-depleted gas 5. The unit 3 is a unit for separation by partial condensation and/or distillation.

The NO₂-depleted gas 5 is compressed in a turbocharger C coupled to a turbine T and produces a compressed gas 7. The turbocharger C may have no aftercooler or may be an adiabatic compressor to maximize the temperature of gas 7. The compressed gas is heated in a heater R at the outlet of the compressor to reach a temperature of between 50 and 150 °C. The first configuration consists in using an electric heater R to heat the gas typically between 60 °C and 130 °C. This configuration has the disadvantage of consuming a significant amount of electrical energy. The fact that the compressor outlet is hot nevertheless makes it possible to limit the power of this heater: the reduction in electrical power of the heater can be between 100% and 20%.

A second configuration consists in using a heat transfer fluid (for example steam or hot water) available in the unit. If the heat transfer fluid is available at a temperature T1 above the required temperature T2 at the inlet of the demercurizer, the heater R consists of a heat exchanger allowing indirect heat exchange between the heat transfer fluid and the mercury-containing gas. This exchanger is placed between the turbocharger C (without aftercooler) and the demercurizer D. In this case, the fact that the compressed gas is hot at the turbocharger outlet also saves on the consumption of heat transfer fluid.

The gas 7 is then demercurized in one or more mercury adsorption reactors D, producing a demercurized gas 9.

The demercurized gas 9 is cooled in a cooler G using a flow of refrigerant fluid W, for example water.

The cooled gas 11 in the cooler G is separated in a unit CC operating at temperatures below 10 °C or even below −50 °C by partial condensation in one or more stages and/or by distillation and/or solidification, producing at least one fluid 13 containing at least 95 mol % or even at least 99 mol % of CO2 and a pressurized stream of gas 15 depleted in CO2 and enriched in at least one air gas.

At least part of the CO2-depleted gas 15 is expanded in the turbine T coupled to the turbocharger C, possibly after being heated in a heater H to a temperature above 10 °C.

### The Expanded Gas 17 Is Evacuated From the Process.

The fluid W which has been used to cool the demercurized gas 9 can be used to heat the gas 15 in the heater H.

This fluid W can also be used to heat the gas 7 in the heater R upstream or downstream of the compressor C, to heat a regeneration gas for a dryer, for example a gas dryer 1 upstream of the unit 3.

It will be understood that the gas 1 does not necessarily contain NO2. In this case, the unit 3 is not necessarily present.

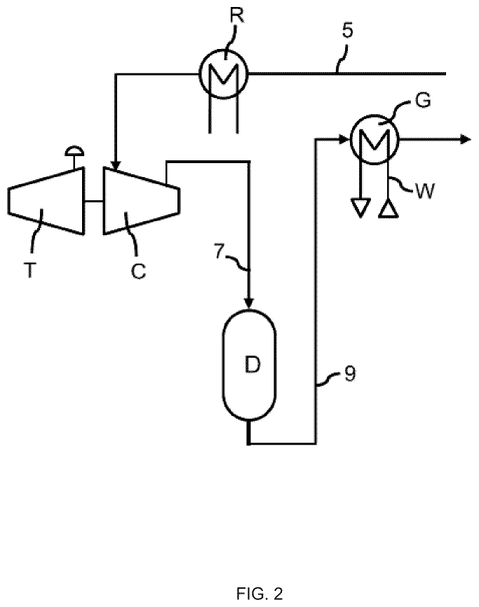

As shown in FIG. 2, the heater R may be placed upstream of the turbocharger C. If the heat transfer fluid is available at a temperature T1 lower than the required temperature T2 at the inlet of the demercurizer D, it is then necessary to place the heat exchanger R upstream of the turbocharger C. The heat transfer fluid is then exploited over the available temperature range and the temperature increase up to the temperature T2 is ensured by the turbocharger. If the heat transfer fluid is cheaper than electricity, or is even free, this configuration avoids consuming electricity in an electric heater.

In the previous configurations, heat is recovered at a cooler G located after the demercurizer D. A heat exchanger can transfer heat from the demercurized gas to the heat transfer fluid. This heat transfer fluid may be the same as that used in the configuration of FIG. 2.

To avoid the use of an intermediate heat transfer fluid, it is possible to use a gas/gas heat exchanger.

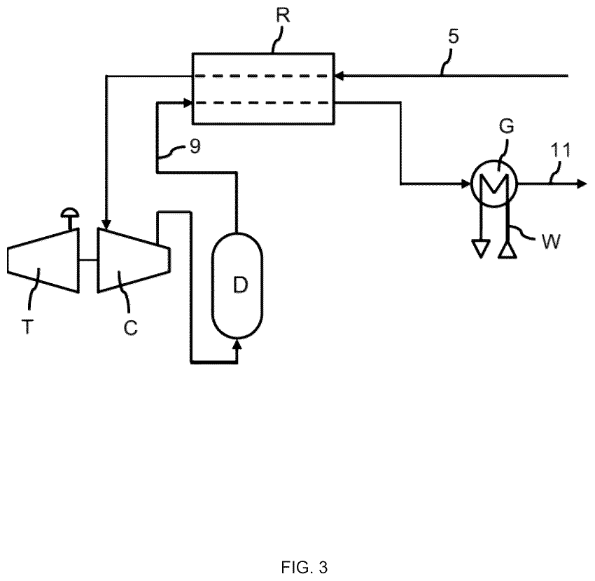

A first configuration consists in using a gas/gas exchanger EC as illustrated in FIG. 3 upstream of the turbocharger C. The gas at the inlet of the turbocharger C is heated by the heat of the gas leaving the demercurizer D. This configuration has the advantage of avoiding the use of an intermediate fluid. The heat produced by the turbocharger C compensates for the heat losses at the demercurizer D. It also makes it possible to reduce the size of the heat exchanger by having an approach greater than 10 °C at the hot end of the exchanger. The gas at 30 °C is heated in the heat exchanger EC to 105 °C, then compressed in the compressor C from which it exits at 130 °C, demercurized at 130 °C and then sent to cool in the heat exchanger EC to cool it down to 58 °C, a cooling step in the cooler G cooling it down to 32 °C.

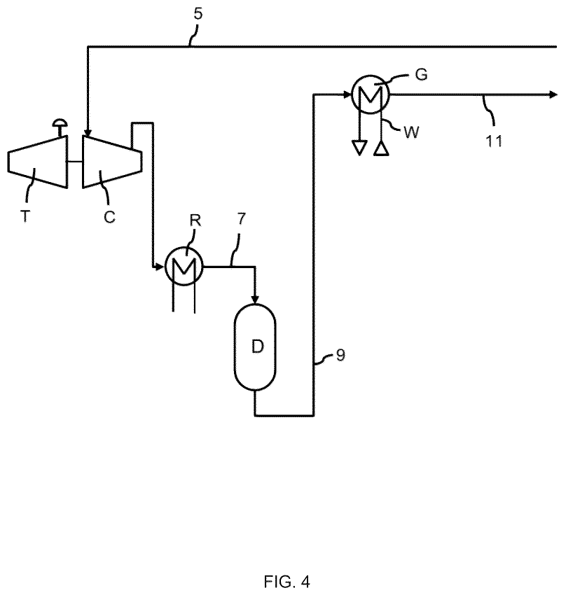

A second configuration, illustrated in FIG. 4, consists in placing the turbocharger C upstream of the gas/gas heat exchanger EC. The gas compressed in C enters the gas/gas heat exchanger EC and the final heating is performed by a final heater R (electric or using a heat transfer fluid at a sufficiently high temperature). This final heater R is necessary to compensate for the heat losses and the approach to the hot end of the exchanger EC. It is in this configuration that the heat produced by the turbocharger is exploited the least. Specifically, the turbocharger C only makes it possible to reduce the size of the gas/gas heat exchanger EC.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-14. (canceled)

15. A process for separating a gas containing CO2, at least one air gas, NO₂ and mercury, involving the following steps:
i) compressing the gas in a turbocharger coupled to a turbine, forming a compressed gas,
ii) heating the gas upstream or downstream of the turbocharger, the gas being heated to a temperature between 50 and 150 °C upstream of the demercurizer, and demercurization of the heated compressed gas in one or more non-regenerative mercury adsorption reactors, producing a demercurized gas,
iii) cooling the demercurized gas,
iv) separating the cooled gas in a unit operating at temperatures below 10 °C or even below −50 °C by partial condensation in one or more stages and/or by distillation and/or solidification, producing at least one fluid containing at least 95 mol % or even at least 99 mol % of CO2 and a pressurized stream of CO2-depleted gas and
v) at least part of the CO2-depleted gas is expanded in the turbine coupled to the turbocharger, possibly after heating to a temperature above 10 °C.

16. The process as claimed in claim 15, wherein the demercurized gas is cooled by indirect heat exchange with a refrigerant fluid, and the refrigerant fluid, preferably water, used to cool the demercurized gas is used to heat the compressed gas in the heater.

17. The process as claimed in claim 15, wherein the compressed gas is heated by an electric heater and/or by a heat-generating fluid.

18. The process as claimed in claim 15, wherein the compressed gas or the gas to be compressed is heated by indirect heat exchange with the gas treated in the demercurizer.

19. The process as claimed in claim 18, wherein indirect heat exchange takes place in a heat exchanger in which the compressed gas or the gas to be compressed is heated and in which the gas treated in the demercurizer cools.

20. The process as claimed in claim 15, wherein the CO2-depleted gas is enriched with at least one air gas, for example nitrogen and/or oxygen and/or argon.

21. The process as claimed in claim 15, wherein the gas is treated to remove NO2 in a unit for removing NO₂ to a concentration of less than 5 ppm, or even less than 1 ppm of NO₂, producing an NO₂-depleted gas upstream of compression in the turbocharger.

22. The process as claimed in claim 21, wherein the treatment to remove the NO₂ is a process of separation by partial condensation and/or distillation.

23. The process as claimed in claim 15, wherein the gas containing CO2, at least one air gas and mercury and NO₂ is composed of combustion fumes.

24. A device configured to separate a feed gas containing CO2, at least one air gas, NO₂ and mercury, the device comprising:
a turbocharger;
a turbine coupled to the turbocharger;
a demercurization unit;
a cooler;
a heater, wherein the heater is connected to heat the feed gas upstream or downstream of the turbocharger;
a separation unit configured to separate by partial condensation in one or more stages and/or by distillation and/or solidification operating at temperatures below 10 °C;
means for sending the feed gas to the turbocharger;
means for sending the compressed and heated feed gas to the demercurization unit to form a demercurized gas;
means for sending the demercurized gas to the cooler and from the cooler to the separation unit to produce at least one fluid containing at least 95 mol % or even at least 99 mol % of CO2 and a pressurized stream of CO2-depleted gas; and
means for sending at least part of the CO2-depleted gas to expand in the turbine coupled to the turbocharger.

25. The device as claimed in claim 24, further comprising means for cooling the demercurized gas by indirect heat exchange with a refrigerant fluid.

26. The device as claimed in claim 25, wherein the heater is downstream of the means for cooling the demercurized gas by indirect heat exchange with a refrigerant fluid and is connected so that the refrigerant fluid, preferably water, used to cool the demercurized gas is used to heat the compressed gas.

27. The device as claimed in claim 24, further comprising an electric heater to heat the compressed gas.

28. The device as claimed in claim 24, further comprising a heat exchanger connected to perform indirect heat exchange between the compressed gas or the gas to be compressed and the treated gas in the demercurizer.
